(19) United States
(12) Patent Application Publication
(10) Pub. No.: US 2021/0034315 A1
(43) Pub. Date: Feb. 4, 2021

(54) NETWORKED SMART FIXTURES SUPPORTING VISUAL MERCHANDISE DESIGNERS WITH REMOTE MONITORING, CONTROL, AND REPROGRAMMING

(71) Applicant: DISNEY ENTERPRISES, INC., BURBANK, CA (US)

(72) Inventors: MARK A. REICHOW, VALENCIA, CA (US); STEPHANIE SAKKAB COLVIN, SANTA CLARITA, CA (US)

(21) Appl. No.: 16/527,490

(22) Filed: Jul. 31, 2019

(51) Int. Cl. G06F 3/147; H04L 29/08; G06Q 10/08

(52) U.S. Cl. CPC G06F 3/147; H04N 7/18; G06Q 10/087; H04L 67/125

(57) ABSTRACT

A merchandise fixture system networking a visual merchandise designer (VIVID) system with a plurality of merchandise fixtures (e.g., shelved structures, vending machines, kiosks, and the like) that are placed in brick and mortar stores and other physical facilities chosen so that consumers can view, use, and interact with the fixtures and the merchandise they are displaying. The merchandise fixtures are “smart” in that they include digital or electronic components that allow them to be monitored, controlled, and reprogrammed remotely using, for example, the VIVID system. The controlling and programming typically include operating a media output assembly that may include visual display devices, speakers, and lighting components, and digital media or content is provided by the VIVID system for use by the media output assembly to create a fixture with visual and audio outputs that attract consumers to the fixture and influence the attracted consumers to interact with and purchase merchandise.

### BACKGROUND

### 1. Field of the Description

The present description relates, in general, to use of physical merchandise fixtures to display, and provide for purchase, products to consumers. More particularly, the description relates to a new design for merchandise fixtures (e.g., kiosks and/or any physical structure used to hold merchandise including vending machines, shelving and walled assemblies (whether or not enclosed, and the like)) to facilitate the efforts of visual merchandise designers.

### 2. Relevant Background

In the world of retail, a fixture is physical structure in a brick and mortar store that is includes shelves and enclosure components for holding and displaying merchandise to customers. In achieving a sale in the retail business, how a retailer chooses to display the merchandise or products they are selling is just as important, if not more important in some situations, than what is being sold. This is because a powerful and successful display design can create an emotional bond for the consumer to a company's brand, and, due to a set of psychological driving forces, consumers tend to be very loyal to brands.

Fixtures in stores give shape and individuality (e.g., a look and feel) to each retail store, and store operators try to use fixtures to ensure that products are displayed and organized in an efficient and eye-catching manner. It is widely accepted in the retail industry that the type of store display fixtures used and the way in which products are displayed in them has a tremendous impact on a retailer's success whether they are selling toys, electronics, clothes, or other products. As a result, there is an ongoing demand for innovative fixtures, and it is crucial for each store to choose high quality and effective fixtures that suit their product and expected customers.

Within the retail industry, visual merchandise designers (or VMDs) are employed to make the best use of fixtures. When a VIVID has a new product line that rolls out, they are tasked with creating a design that celebrates the product, captures the customer's eye, highlights a link between the product and a brand, and influences the customer's decision-making process (e.g., to consider and to eventually buy the new product). Unfortunately, the tools the VIVID has to work with are presently limited and have not changed significantly for many years. These tools include lighting, music, and the use of printed materials that are mailed out to each store for assembly by local store staff. On occasion, some high-end retail stores may have separate (from the fixture) digital signage they use to display a commercial or image of the product; this digital signage conveys information to the customer but does little to convey a sensory appeal to the customer. However, for most stores, the VIVID is forced to rely on a static fixture in or on which to provide their messaging, which, as a result, provides fixed theming. The only thing that has changed in fixture design in the last hundred years or more is the incorporation of under lighting, some more creative theming through the use of materials (e.g., old wood, brick, and so on), and e-ink price tags to the conventional merchandise fixture.

Brick and mortar stores are closing at an astonishing rate in part due to unsuccessful competition with the e-commerce or digital platform and its ability to provide better pricing and bigger choices. For businesses, paying the overhead cost of a physical space to sell the same product that can be sold online is proving more and more undesirable. However, this decision making formula can likely be rebalanced by giving customers improved in-store shopping experiences by providing a new fixture design for use by VMDs that communicate not only at an information level but also at a sensory level to enhance the customer experience in ways not possible before now. The new fixture design preferably would be adapted to provide VMDs the tools desired and useful in enabling them to more effectively display and encourage customer discovery, exploration, and purchase of a wide variety of merchandise.

### SUMMARY

In brief, a smart merchandise fixture or “unit-system” is provided along with a platform that networks a visual merchandise design to one or more unit-systems. These unit-systems are placed in brick and mortar stores and other physical facilities in locations so that consumers can view, use, interact with, and even purchase, from the unit-systems or smart merchandise fixtures, the merchandise that is being displayed. Each unit-system can be a shelf-type fixture unit, a vending machine, a kiosk, or anything where merchandise is held and displayed at a point where a customer makes a purchase decision.

It will become clear that each unit-system or smart merchandise fixture (or simply merchandise fixture or fixture) is integrated and assembled with various imaging devices, lighting, audio, sensors, controls, playback systems, networking devices, computing components/resources, cameras and/or the like. This allows each unit-system to be used as a palette or canvas for a visual merchandise designer (VIVID) to implement their designs using new artistic methods and techniques afforded by the new tools incorporated into each unit-system or by the platform networking the unit-systems and a central server(s). The “platform” is a digital network system using various components that connects various single or multiple unit-system to a central server (e.g., a VIVID's computer system), and the platform can be used to allow the central server to communicate bi-directionally in real time to upload, download, or share content and data. The methods and techniques implemented by or facilitated by the new unit-system and platform include artistic and technical choices that guide the creation and programming of content used to operate the various components and devices in each unit-system in support of a VIVID in encouraging product sales including linking brands to the products.

Stated differently or expanding on this discussion, a merchandise fixture system is provided that networks a visual merchandise designer (VIVID) computer system (or central server or the like) with a plurality of smart merchandise fixtures (e.g., shelved structures, vending machines, kiosks, and the like) that are placed in brick and mortar stores and other physical facilities chosen so that consumers can view, use, and interact with the fixtures and the merchandise they are displaying. The merchandise fixtures are “smart” in that they include digital or electronic components that allow them to be monitored, controlled, and reprogrammed remotely using, for example, the VIVID system. The control and programming typically includes operating a media output assembly that may include visual display devices (such as thin monitors including liquid crystal displays (LCDs) and the like), speakers, and lighting components, and digital media or content is provided by the VIVID system for use by the media output assembly to create a fixture with visual and audio outputs that attract consumers to the fixture and influence the attracted consumers to interact with and purchase the merchandise. The media or content is chosen to suit the displayed merchandise and, in some cases, the expected or target audience/consumers using the merchandise fixture, and it can be modified or replaced with new content provided by the VIVID system to implement the reprogrammable feature of the new merchandise fixture system.

By adding reprogrammable digital functionality in each unit-system or smart merchandise fixture, the retail industry is significantly changed with its effectiveness improved. The remote reprogrammable feature also adds provides other opportunities to the user of merchandise fixtures and can aid in their strategic planning and effect their business models for displaying and selling goods. The new smart merchandise fixture has imaging technologies (which may include commercial digital displays of various form factors and/or other image generating or creating devices) that can be operated around the clock, periodically, or at intervals. The imaging technology assemblies (which may sometimes be labeled displays herein but are not limited to conventional monitors or the like) may have various form factors, which can be integrated into the fixture in a camouflaged fashion to reveal or provide creative media-themed designs for the smart merchandise fixtures. A smart merchandise fixture or unit-system, with its media output assembly, may include, or have integrated in the physical fixture structure, speakers and lights to enhance a visual and audio output.

Remote monitoring or tracking of the smart merchandise fixture or unit-system, its merchandise, and interactions with consumers (e.g., a mobile app for monitoring and/or analyzing) consumer-merchandise/fixture interactions) may be achieved with the inclusion of a monitoring system in the smart merchandise fixture or unit-system. The monitoring system may include cameras, various types of sensors, triggers, and/or radio nodes. All components of the unit-system can be thought of as “show components” for a show system that is configured and operated to play back in the unit-system as desired from a playback platform (part of the media output assembly that may be Videro or another useful media output control software product). The playback platform or media output assembly's controller may be capable of uploading new show content and programming from the VIVID system (or another source) at any time desired by a system or fixture operator. The controller may be a “show controller,” as these provide the ability to execute a show script according to show timing and triggers that generate synchronized outputs that are in a form and protocol used by the “show components” in the entertainment field. For example, the show controller may put out standardized signals that an audio or video player or a lighting fixture may use to start/pause their operation.

In some embodiments, a “master fixture” or “master unit-system” with a configuration similar to smart merchandise fixtures or unit-systems in the field/stores, is located at a corporate or central headquarters such as where operators access the VIVID system, and a VIVID can iterate new designs as new products or marketing campaigns roll out. The VIVID can create assets (or content) for and program the master fixture to a desired state. Programs and/or digital content can then be downloaded (from the VIVID system or another serving device(s)) to all fixtures for which it is desired to match the state created on the master fixture (e.g., all smart merchandise fixtures or unit-systems with a similar physical display assembly/structure that are to be used in the same way to display/sell a particular piece of merchandise). Cameras integrated inside or on fixtures can monitor merchandise and provide images that can be processed by the VIVID system (or at each smart merchandise fixture) to provide feedback, such as feedback to a corporate headquarters, on the stocking and inventory of merchandise and whether a desired display design is achieved successfully by a set of the smart merchandise fixtures. Cameras integrated on the outside of the fixture's structure (or directed outward instead of at the merchandise) can provide images for use in performing crowd analytics (such as in the VIVID system) to provide data or statistics on customer behavior (how do customers interact with merchandise, how do customers interact or receive the smart merchandise fixture and its current programming/content, and so on). This creates hard data for use in carrying out or generating a business strategy and for use in the future when a VIVID reprograms a fixture.

More particularly, a system is provided for remotely monitoring and reprogramming smart fixtures used to display products. The smart fixture system or network includes a display server system (e.g., a VIVID system) including memory storing media content configured for use with a smart fixture in which are positioned one or more of the products. The smart fixture system also includes a plurality of the smart merchandise fixtures communicatively linked with the display server system to receive the media content and, in response, generate a product display. In practice, each of the smart merchandise fixtures typically includes: (a) a physical display assembly displaying the products; and (b) a media output assembly mounted on the physical display assembly and including at least one display element (or imaging technology element or component) operable by a controller to provide a displayed image proximate to the products using the media content.

In some embodiments, the display server system operates to generate and transmit a second set of media content to the smart merchandise fixtures to reprogram the at least one of the smart merchandise fixtures. Further, the controller of the smart merchandise fixtures responds to the reprogramming by operating the display element to provide a second displayed image using the second set of media content. In such embodiments, the media content may include a program defining timing of operations of the display element to display the media content and the second set of media content includes a second program defining a second timing of operations of the display element to display the second set of media content. Also or alternatively in such systems, each of the smart merchandise fixtures may include a monitoring system sensing data related to the products in the physical display assembly including at least one of inventory levels and consumer interaction with the smart merchandise fixture or the products, and the sensed data typically is transmitted to the display server system for analysis.

Further, in such embodiments, the second set of media content is generated in response to results of the analysis. Also, the analysis includes running an image analysis algorithm to confirm compliance by operations and configuration of the smart merchandise fixture associated with the sensed data with a product display design for smart merchandise fixtures assigned to the smart merchandise fixture associated with the sensed data. Still further, the second set of media content may provide additional content modifying the displayed image so that the second displayed image includes a changed or additional component relative to the displayed image or provides content that differs such that the second displayed image differs from the displayed image.

In the same or other embodiments, the display or imaging technology element may include a monitor and the media content includes a video. Additionally, the media output assembly may include lighting, and the media content may define at least one of the following for operating the lighting: a set of output colors, a timing of operations of one or more lights in the lighting, and a color rendering index (CRI) for lighting the products in the physical display assembly. Still further, the display element may take the form of a liquid crystal display (LCD), a poster display element switchable from a static mode to a motion mode, or a camouflaged digital signage element.

An interactivity component or assembly may be provided in the smart merchandise fixture to emulate the look and feel of an e-commerce website or experience that is provided to consumers by the maker or distributer of the products in the physical display structure. In this way, the consumer is able to interact with a physical product but still have the comfort and familiarity to the digital platform they are used to dealing with in making purchases. For example, the interactivity component may provide a GUI similar to that provided by an e-commerce platform, and, in some cases, the consumer may simply transfer or mirror their live session to and from their mobile device or otherwise provide connection to an online e-commerce platform. In some implementations, a consumer may have a physical interaction with displayed products and then use the interactivity assembly of the smart merchandise fixture to complete their purchase order. For example, a shopper may not be able to find their size or a color they want in the fixture, and an application on the interactivity component (e.g., a computing device in the fixture) can take them directly to the web store associated with the product that will ship the size and/or color they wish to their home (such as at the click of a button, upon a voice command, or the like) and confirm the sale. In effect, this feature of the smart merchandise fixture connects the physical experience to an e-commerce experience and a company's much larger and varied inventory.

### BRIEF DESCRIPTION OF THE DRAWINGS

FIG. 1 illustrates a functional block diagram of a smart merchandise fixture network or system according to the present description;

FIG. 2 illustrates a smart merchandise fixture of the present description in an off or non-display mode;

FIGS. 3A-3D illustrate the smart merchandise fixture of FIG. 2 in an on or display mode from a side perspective view, a front perspective view, a top perspective view, and a rear perspective view, respectively, to better show different features of the fixture;

FIG. 4 illustrates the smart merchandise fixture of FIGS. 2-3D in an on or display mode similar to that shown in FIG. 3B but after reprogramming to modify the media content to suit differing products displayed in the fixture;

FIGS. 5A and 5B illustrate the smart merchandise fixture of FIGS. 2-3D similar to views of FIGS. 3A and 3B but with additional digital content or reprogramming to add display features to those provided in the on or operating mode shown in FIG. 4;

FIG. 6 illustrates the smart merchandise fixture of FIG. 5B after further reprogramming to modify the digital content for the products (e.g., to try a different marketing campaign for same product line);

FIG. 7 illustrates the smart merchandise fixture of FIG. 3A with a modification to include a camouflaged digital signage component on its end cap portion of the media output assembly;

FIG. 8 illustrates the smart merchandise fixture of FIG. 3A with a modification to include a magic movie poster-type display element on its end cap portion of the media output assembly in place of digital display element (e.g., LCD or the like); and

FIG. 9 is a schematic of a networked system of smart merchandise fixtures of the present description including a master fixture used to create digital content and programming for remote but networked smart merchandise fixtures or unit-systems in brick and mortar stores/locations.

### DETAILED DESCRIPTION

New “smart” merchandise fixtures or “unit-systems” are described herein that are configured to employ entertainment technology such as lighting, audio, content display, and the like that is performed in a coordinated fashion according to a show script implemented by a show controller to evoke emotional and sensory connections with consumers. The merchandise fixtures described herein may also collect monitoring and tracking data for contained and displayed merchandise, and this data is passed to a visual merchandise designer (VIVID) system (e.g., any remote computing device functioning as taught herein. The smart merchandise fixture is smart because the VIVID system provides digital media or content for the smart merchandise fixture to playback using an integral or onboard media output assembly, and this media/content and operations of the media output assembly can be remotely modified (or “reprogrammed”) by the VIVID system on one or more smart merchandise fixtures in network or system of such fixtures. The merchandise fixtures described herein recognize that the unique place in a retail environment where customers make the decision to acquire goods and services is often at the merchandise fixture itself and that goods and services can be presented much more effectively using entertainment technology and techniques. As a result, the purchase experience is made more satisfying and enjoyable by the new technology and techniques described herein.

This new digital smart merchandise fixture is configured so as to provide a more complete tool set for VMDs that evolves from static paper, print, and paint medium to a digital medium that can readily be modified and reprogrammed for differing product lines, differing target consumer groups, and differing marketing strategies and/or campaigns. Hence, the smart merchandise fixture is not merely a display case with monitor that presents a single commercial. Instead, a system or network with the new unit-systems or smart merchandise fixtures allows a VIVID to use a remote computer system (or VIVID system/server) to download new content (and control or fixture programs for how and when to use such content) that is developed remotely (such as upon a “master fixture”) to one-to-many smart merchandise fixtures over a digital communications network. This will significantly improve brand control by presenting goods and services in a sensory context that is consistent with and precisely matches the brand owner intent, and it will also save on time and labor cost involved with rolling out new products and advertising campaigns. The smart merchandise fixture often may also be designed to take inventory of merchandise stock and report the inventory data (e.g., to a distribution center, to the company producing the product, to a company providing the fixture, and so on). The merchandise fixture or unit-system is also smart in that it may be designed for observing customer behavior around a fixture design and/or a line of merchandise. In some embodiments, the merchandise fixture or unit-system is also “smart” in that it is configured to provide real time interactivity with a nearby consumer. In some ways, the new fixture system or “platform” can be thought of as connecting brick and mortar commerce to e-commerce and its features provided through use of digital content.

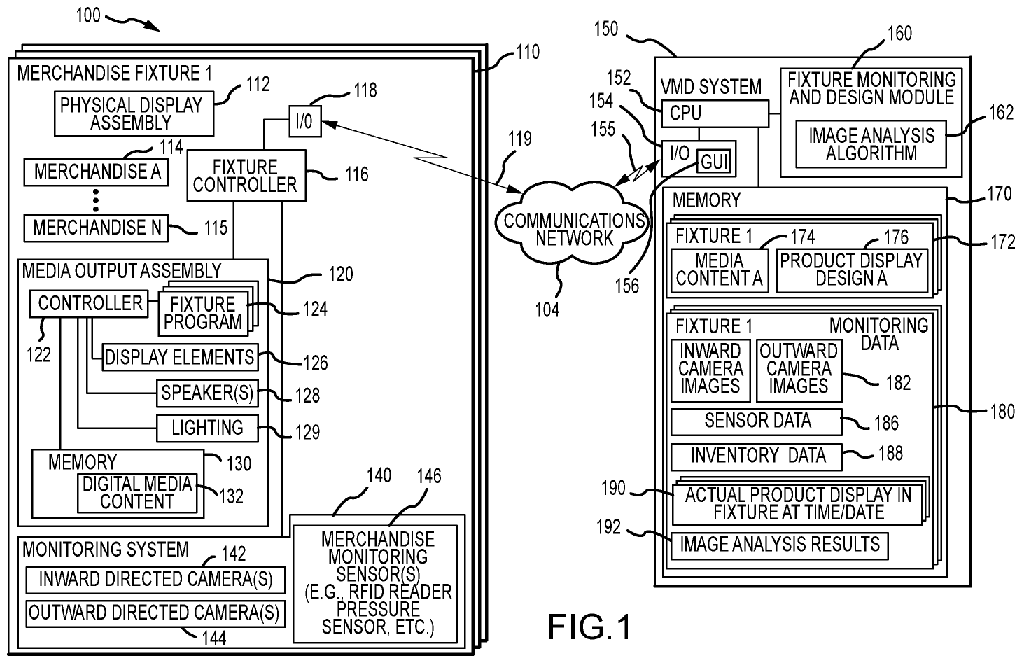

FIG. 1 is a functional block diagram of a merchandise fixture system or platform 100 of the present description. The system 100 includes one-to-many smart merchandise fixtures or unit-systems 110 that are communicatively linked as shown via arrows 119, 155 in a wired and/or wireless manner via a digital communications network 104 with a visual merchandise designer (VIVID) or product manager system 150. Each smart merchandise fixture 110 is configured for displaying, e.g., for purchase by retail consumers (not shown) in a brick and mortar store or other facility. The VIVID system 150 via the network 104 and communication links 119, 155 is able to remotely monitor, control, and reprogram (e.g., with new digital content, with a new product display design, and so on) the smart merchandise fixture 110 independently or as part of a larger set. For example, one smart merchandise fixture 110 may be identified through the monitoring taught herein as underperforming other fixtures, and the operator (e.g., a VIVID) of the system 150 may take steps to reprogram the fixture 110 to attempt to increase sales of merchandise from the smart merchandise fixture 110. In other cases, though, a new product line may be introduced, and it may be useful to reprogram or update the display content (or media) used to operate a plurality of smart merchandise fixtures 110 with a single push of new content, show scripts, sound and audio instructions and the like to concurrently reprogram all the fixtures used to display and/or sell the new product line across a metro area, across a state, across a country, or even over multiple countries.

The merchandise fixture includes a physical display assembly 112 that is used to contain and display an inventory of one or more products or items of merchandise 114, 115, which may change on an ongoing or periodic basis. This change out or rotation of merchandise 114, 115 is one of the driving forces behind the design and development of the system 100, which allows operators (or VMDs) to reprogram the smart merchandise fixture 110 upon changing of the merchandise 114 and/or 115. The assembly 112 may take nearly any useful form for supporting and presenting merchandise 114, 115 to a potential consumer such as a structure with one or more shelves supported on a back wall and/or side walls and with one or more exterior surfaces (e.g., an exposed outer portion of a side wall or the like). The display assembly 112 may be enclosed such as when the assembly 112 takes the form of a kiosk, a vending machine, or the like such as with a front exterior wall that may be transparent (or at least translucent) or have windows to allow a consumer to see displayed products as well as visual outputs of the media output assembly. Other implementations of the assembly 112 may be open to allow and encourage consumers to reach in and select products (such as to touch and feel, to try on, and/or to otherwise interact with) for purchase.

The merchandise fixture or unit-system 110 is digital or “smart,” and, in this regard, the smart merchandise fixture or unit-system 110 includes a fixture controller 116 that may take the form of nearly any computing device (e.g., with a processor and/or other hardware operable to execute or run code/software) configured to perform the functions described herein. The fixture controller 116 manages operations of input/output (I/O) devices 118 that facilitate wired or wireless communications 119 with the VIVID system 150 via network 104. The fixture controller 116 further manages or controls operations of a media output assembly 120 and a monitoring system 140 provided on or in the physical display assembly 112. In some embodiment, the fixture program 124 provides interactivity in real time with a customer based on the output from the monitoring system 140 by changing the operation of the media output assembly 120 (e.g., changing or selecting displayed content or a soundtrack or lighting based on input/interaction data for a particular consumer inspecting the merchandise 114, 115 or interacting with I/O 118 (e.g., a touchscreen or pad as may be found on a kiosk or vending machine).

The media output assembly 120 is provided in the smart merchandise fixture 110 so that it can operate to produce a product-specific and rich sensory experience that will entice/attract, educate, and influence consumers with regard to the merchandise 114, 115. The assembly 120 can provide a wide variety of displayed images, sound (music, recorded messages, and so on), and lighting. To this end, the assembly 120 includes a controller 122 (e.g., a processor running software to provide control functions), and the controller 122 runs software and/or executes code/instructions provided in a fixture program 124. The assembly 120 includes memory 130 storing digital media content 132, which is downloaded from the VIVID system 150 and which may be suited/selected specifically for merchandise 114 and/or merchandise 115. The fixture program 124 is also provided by the VIVID system 150 and defines which portions of content 132 are to be used in the unit-system 110 and timing of playback or use of the content 132 by the assembly 120, setting lighting intensity and color (e.g., select lighting conditions that complement a product's or package's coloring), playing audio (e.g., play audio that evokes a place where the product would be used), activating lighting effects such as sparkles or flashes, and the like. One or more display elements 126 (e.g., liquid crystal displays (LCDs) or the like), speakers 128, and lighting components 129 are used to produce the activated effects. In other cases, the communications over links 119, 155 from the VIVID system 150 may include real time commands to play/use portions of the content 132 to operate the assembly 120 (e.g., provide real time, remote control capability of the smart merchandise fixture 110 to interact with a consumer(s)).

The merchandise fixture 110 is also “smart” in the sense that the monitoring system 140 allows an operator of the VIVID system 150 to remotely monitor and/or track operations of the smart merchandise fixture 110. The monitoring system 140 includes an inward directed/focused camera(s) 142 for capturing images of the interior spaces of the assembly including the merchandise 114, 115. These images may be useful for determining whether or not a present display configuration aligns with a display design generated and assigned to the smart merchandise fixture 110 by an operator of the VIVID system 150. These images may also be useful in performing inventory of the merchandise 114, 115. The monitoring system 140 also includes an outward directed/focused camera(s) 144 that is used to capture images of the consumers as they view the smart merchandise fixture 110 and/or as they interact with the merchandise 114, 115. Additionally, microphones (not shown) may be provided with such cameras 144 to monitor audible reactions of consumers to the merchandise 114, 115 and/or the output of the assembly 120 during its operations. The monitoring system 140 may also include one or more merchandise monitoring sensors 146 that are adapted for sensing or collecting data on the merchandise. For example, the sensors 140 may include sensors useful in monitoring and/or tracking inventory levels of the merchandise 114, 115 such as barcode or similar scanners, RFID readers (when RFID tags are provided on the merchandise 114, 115), pressure/weight sensors on shelves of the display assembly 112, and the like. Sensors, such as thermal devices or behavior monitoring sensors, may also be used in place of the cameras in some applications to track movements of consumers near and about the smart merchandise fixture 110, and the term “sensors” is intended to be construed very broadly to include nearly any presently developed or yet to be developed technology useful for such functionality.

The VIVID system 150 may include a server or otherwise be configured for performing the functions taught herein such as with a processor 152 executing code/instructions or running software to provide a fixture monitoring and design module 160. The processor 152 also manages operations of I/O devices 154 that facilitate communications over network 104 and links 119, 155 with each of the smart merchandise fixtures 110. The module 160 may be configured to generate one or more graphical user interfaces (GUIs) 156 to allow an operator (e.g., a VIVID, a fixture operator/owner, or the like) to view data pertaining to the smart merchandise fixtures 110 and content being developed on or ready for distribution from the system 150 and to input data (e.g., selection of content and/or operating programs for unit-systems 110).

The system 150 includes data storage or memory 170 that is used to store files 172 for each smart merchandise fixture 110, and these files 172 include media content 174 and a product display design presently chosen for use with the particular fixture 110. The media content 174 is downloaded to the smart merchandise fixture 110 matching the file (e.g., identified with a serial number or the like) 172 and stored in its local memory 130 as shown at 132. In this way, an operator of the system 150 is able to remotely program the smart merchandise fixture 110, and they can also reprogram the fixture by downloading new content 174 for use as content 132 in the media output assembly 120 (such as when a new product 114, 115 is displayed in a smart merchandise fixture 110, when a new target audience is selected for the merchandise 114, 115, when a new advertising campaign is begun, and so on).

Each fixture 172 may also have assigned a product display design, which may be unique for the fixture or be a common design used for a two or more smart merchandise fixtures 110 (e.g., to provide common theming for a company or a company's product). The product display design 176, which is set by an operator of the VIVID system 150, may define how and where product 114, 115 is to be arranged/displayed in the display assembly 112, how the display assembly 112 is to be configured (shelving and so on), how the media output assembly 120 is to be designed/positioned in the display assembly 112, and so on.

The memory 170 may further be used to store a monitoring data file 180 for each smart merchandise fixture 110. The monitoring data 180 may include images 182 from the inward directed camera 142 and images 184 from the outward directed camera 144. The module 160 may include an image analysis algorithm 162 that can be used to process the images 184 of consumers interacting with the smart merchandise fixture 110 to determine consumer information such as emotions while viewing the display output, while interacting with the merchandise, and/or identifying inspections with or without buying of the goods. The results of this analysis can be stored as shown at 192 in a fixture's monitoring data file 180 for later use in reprogramming the unit-system 110 by a VIVID or other operator of the system 150. The file 180 further is used to store sensor data 186 output by the merchandise monitoring sensors 140 and to store inventory data 188 for the merchandise 114, 115 for the smart merchandise fixture 110 (these two types of data may overlap). Further, the memory 180 may be used to store actual product display 190 for the fixture at a particular time and day, and this may include (or take the form of) images 182. This information 190 can be used for comparison with the product display design 176 or “goal” to determine if an operator/user of the smart merchandise fixture 110 is complying with the design 176 or whether corrective measures are required to place the fixture in compliance or alignment with the predefined display design 176.

The system 100 is useful for combining virtual (e.g., aspects desirable with e-commerce) with a physical experience (e.g., trying on clothes and shoes, enjoying touch and feel of a product, and so on). The system 100 is adapted to make it fun for consumers to interact with the smart merchandise fixtures 110 and to make the consumer want to buy the merchandise 114, 115. The system 100 allows its operators (users of the VIVID system 150 to control both merchandising/marketing aspect of product sales (e.g., how a product is presented to a potential buyer) and also to control inventory/stock (e.g., is fixture being adequately replenished in a timely manner and, if not, transmit instructions to local operator of fixture, is a product line not selling or only selling slowly and, if so, can the fixture be reprogrammed to increase sales, and so on). The image analysis algorithm 162 can sample images 182 of fixtures to check inventor of merchandise 114, 115 in display assembly 112. It can also process the images 184 of people reaching in and out of the fixture's display assembly 112, which is an indication of attraction (or level of interest), and what fraction of these attracted people follow through with a purchase. Further, the images 182 can be processed by the algorithm 162 (or another software tool) to check whether the smart merchandise fixture 110 is configured for providing a proper or desired display (e.g., actual display 190 matches display design 176 of particular fixture).

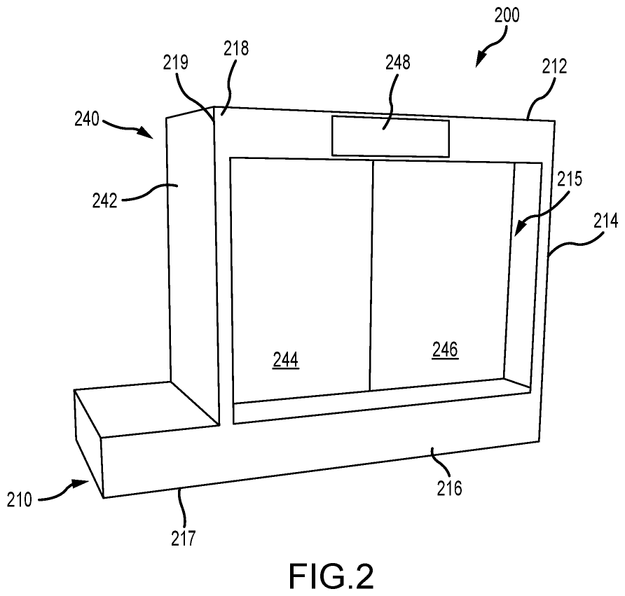

With this general understanding of a network or system of fixtures understood, it may be useful to turn to more specific examples of fixture design and/or implementation. FIG. 2 illustrates a smart merchandise fixture 200 of the present description in an off or non-display mode (e.g., prior to operation of the media output assembly 240 to display/output digital content or perform the current programming for the fixture 200). The fixture 200 includes a physical display assembly 210 that is configured for supporting, orienting, containing, displaying, and otherwise presenting one or more products (not shown in FIG. 2), and the “products” may be any items for consumption or purchase (often, called “retail items” herein as a form of shorthand) by a consumer interacting with the fixture 200 not shown but readily understood by those in the arts. Products may even include services where those services can be represented by physical or virtual objects at fixture 200, such as a cruise or vacation voucher, movie tickets, and the like

The particular design and components of the assembly 210 are not limiting to the fixture 200 and can take a wide variety of forms including a typical merchandise fixture, a kiosk, and/or a vending machine form factor. The example of a design shown for assembly 210 includes rectangular shell or enclosure for holding products on shelves, hanger rods, and the like. Such a shell or enclosure is provided by a rectangular top or cap piece 212, a rectangular bottom piece or base 216, and rectangular end or side pieces or walls 214 and 218 that are interconnected to form a box with front and back openings (which may be filled with glass or the like or left open to allow consumers to reach in and physically touch and select products for trial and purchase). A leg or exterior base 217 is provided on one end of the base 216 to define an end cap display area or space of the assembly 210, and the exterior side or surface 219 of end wall 218, and this exterior side/surface 219 may be used to support one or more components of the media output assembly 240. An interior wall 215 extending between the side walls 214 and 218 is included in the physical display assembly 210 to provide a backdrop for the two openings (front and back display openings) as well as to provide a support surface for items of the media output assembly 240.

In this regard, the media output assembly 240 of the fixture 200 includes a first and second (or left and right) imaging technology elements 244 and 246, which are provided in this examples as display elements for convenience sake but not in a limiting sense, that are mounted on a first or front side of the interior wall 215 and oriented to have their front or output side (e.g., a monitor screen) facing the opening of the enclosure formed with walls/pieces 212, 214, 216, and 218. The display elements 244, 246 may take the same or different forms, with one prototype of the assembly 240 utilizing large (e.g., 48 to 85-inch or larger) liquid crystal displays (LCDs) to display digital visual content in the form of still or video content. This visual content generally is chosen or programmed specifically to suit the products or items placed in the physical display assembly 210 near (in front of) the display elements. For example, the visual content may depict or evoke a place (e.g., a beach when displaying swimwear) or scene (e.g., a festive holiday tree and fireplace when displaying holiday gifts) that is consistent with the brand image of the product. An intent of fixture 200 is to produce a sensory experience that is above and beyond merely providing information or answering questions about the product. In other embodiments, other monitor devices such as organic liquid emitting diode (OLED) displays are utilized, and the front display screens may be planar as shown or curved in some cases. The media output assembly 240 may include additional display elements such as an end cap or exterior sidewall display element 242 on side/surface 219. In fixture 200, a fourth display element 248 is provided in the front (or first) side of the top or cap component 212 of the physical display assembly 210 to display additional digital content.

The digital content displayed on the display element 242 may differ from that shown on display elements 244 and 246 and be chosen to suit a marketing program for a product provided on or near the exterior base 217 (e.g., on shelves above the base 217 or on the base 217 itself) or to provide a desired look and “feel” for the fixture 200. The content provided to display element 244 may be the same or different than that provided to display element 246 and/or may be coordinated with display element 246 (such as to provide a much larger image, to move content to and from the display elements 244, 246).

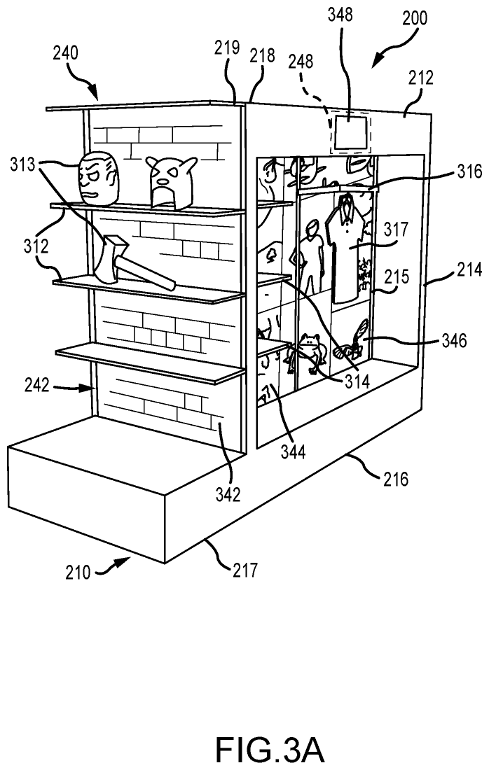

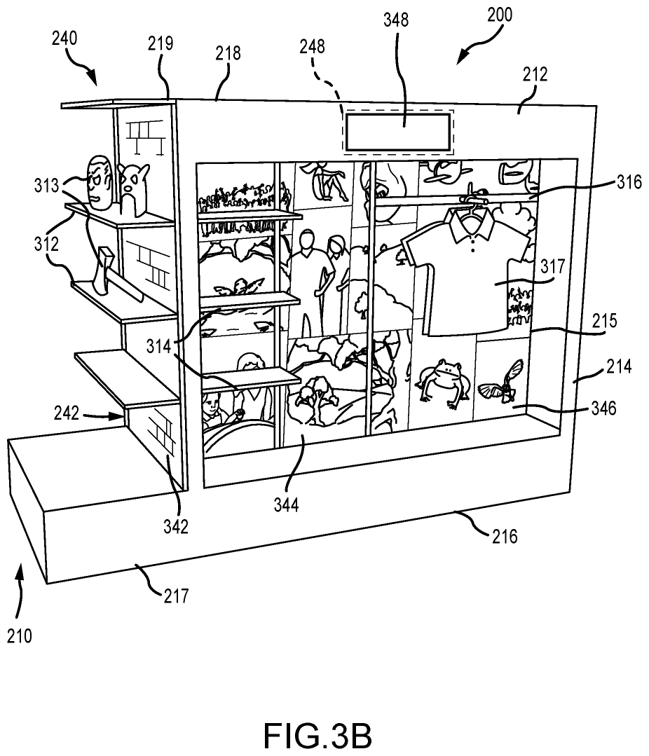

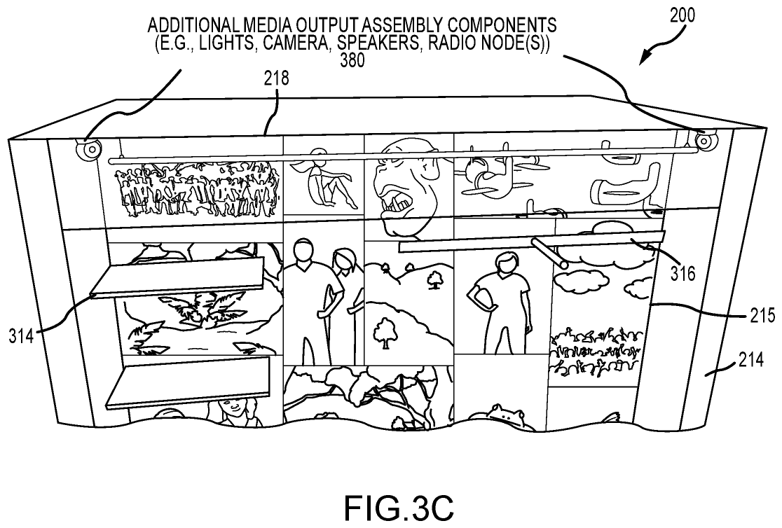

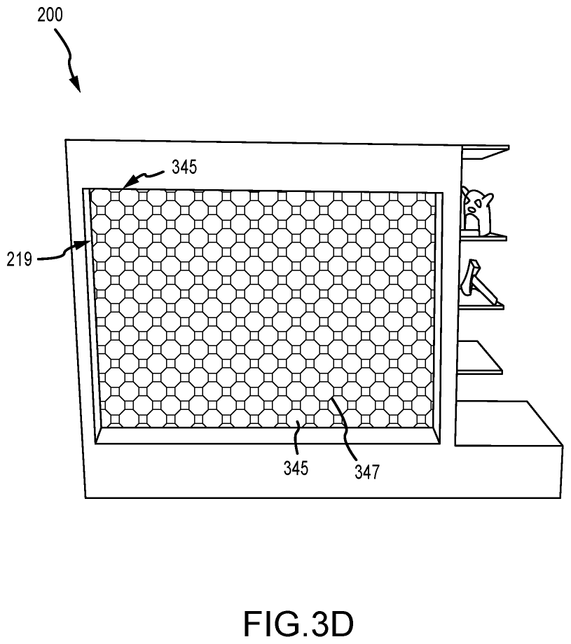

FIGS. 3A-3D illustrates the smart merchandise fixture 200 during its use in an on or display mode with an exemplary product programming and content (first content provided according to a first program/programming) for a first or a particular product or set of products (product line). As shown in FIGS. 3A and 3B, physical display assembly 210 has been modified to include exterior shelves 312 adjacent or near the side or end cap display element 242, and products 313 are placed on the shelves 312. The digital content 342 displayed on or by the display element 242 may be a still image as shown providing a desired backdrop or theme for the fixture 200 that may be chosen to suit the products 313 (or the product line or brand of the products 313), and this content 342 may be a video or may be a still image as shown (i.e., a brick pattern).

The display elements 244 and 246 may be operated (e.g., by a controller of the media output assembly 240) to display the same or, as shown in FIGS. 3A and 3B, different digital content 344 and 346 in the form of a still image or a video. The displayed digital content 344 and 346 may be the same or differ between the display elements 244 and 246, and the chosen content (by a VIVID system 150 shown in FIG. 1) to provide a background for products (e.g., clothing 317) positioned in the fixture's recessed (or other) space provided by or defined by the top/cap 212, base 216, and sidewalls 214 and 218. As shown, to support product display, the fixture 200 includes shelving 314 and hanger rod 316. The display element 248 may be independently and sequentially or concurrently operated as part of the media output assembly 240 to provide additional displayed content (again, still image(s) or video) 348 to suit the fixture 200 and/or its displayed products 313 and/or 317 (e.g., to identify the brand of products 313 and 317, to identify a product line including products 313 and 317, or to otherwise contribute to a programming assigned to the fixture 200 in the present operating or on mode shown in FIGS. 3A-3C. Images 348 may be a brick or wooden pattern coupled with dim, moody product lighting and perhaps bird noises to stimulate a customer's senses to evoke notions of a lodge or park experience that may be consistent with displaying an outdoorsy product such as binoculars, camping gear, and the like. On the other hand, an icy background with bright product lighting and sounds of an outdoor activity such as skating or skiing stimulate senses to evoke notions of a ski lodge that is suited for displaying goggles, gloves, scarves, and other cold-weather gear. These examples are useful for showing the new merchandise fixture is useful for stimulating senses (not merely conveying information) to evoke responses in the customer.

As discussed with reference to FIG. 1, smart fixtures of the present description can be configured for and used to provide additional media output assembly components than monitors/display elements and to provide components of a monitoring system (such as system 140 in FIG. 1). In this regard, FIG. 3C illustrates a pair of exemplary positions in the product space defined by the cap 212, base 216, and sidewalls 214 and 218 for additional media output assembly and monitoring system components 380. For the media output assembly 240, these components 380 may include lights (e.g., LEDs to provide lighting effects, to provide high color rendering index (CRI) light to ensure products 317 are lighted in a desired manner, and so on) and speakers (e.g., to provide audio output/content to suit the products 317 and/or to support the displayed content 342, 344, and/or 346). For example, the color, temperature, and intensity of high CRI lighting can make products 317 appear more visually accurate by creating contrast, reducing contrast, compensating for environmental or parasitic lighting so viewers sense accurate colors of products 317.

For a monitoring system provided in the fixture 200, the components 380 may include inward and/or outward directed cameras for capturing images of the configuration of the fixture's physical display assembly 210 and products 317 (and their arrangement for monitoring compliance of with a product display design and quantity for inventory) and for capturing images of interactions with the fixture 200 and its displayed/contained products 313 and 317. An audio sensor/receiving (or radio node) may be included in components 380 to capture the audio output of the fixture (is this aspect complying with the fixture programming and product display design?) as well as speech and sounds related to interactions with and comment upon the fixture 200 and/or its products 313 and 317. The captured monitoring data from components 380 may then be transmitted to a VIVID system (such as system 150) for analysis as discussed above with reference to FIG. 1, such as to determine whether the fixture 200 is conforming to a product display design, whether additional inventory is required and which products are or are not selling well, and/or whether the present product display design/program for fixture 200 is performing as desired for the product/product line.

FIG. 3D illustrates the second or back side of the fixture 200, and this figure is useful for illustrating that a media output assembly 240 may be configured to include more than conventional monitors to provide a desired visual effect as part of the fixture's programming for a product display. As shown, the cap/top 212, base 216, sidewalls 214, 218, and interior wall 215 are configured to define a second recessed or interior space opposite the first one shown in FIGS. 3A-3C. A back or second surface 219 of the interior wall 215 is used to support a backlighting element 345 is provided to provide backlighting (e.g., to provide an RGB back-lit wall of one-to-many colors or colored patterns (that may be continual or varying over time)). A foreground display element 347 may be positioned in the recessed space over the backlighting element 345 or interposed between the element 347 and a space in which a consumer observing the fixture 200 would be located when the fixture 200 is in use. The foreground display element 347 may take a wide variety of forms such as a sheet of material providing a layered perforated pattern as shown, a scrim (which may be provided in the front recessed space, too or alternatively, to disguise the presence of the monitors 244, 246), or other useful forms to achieve a desired visual effect for the scrim 200. The backlighting element 345 may be reprogrammable by a remote VIVID system 150 such as by allowing the color(s) and/or color patterns to be modified over time such as when a new fixture program is downloaded to fixture 200.

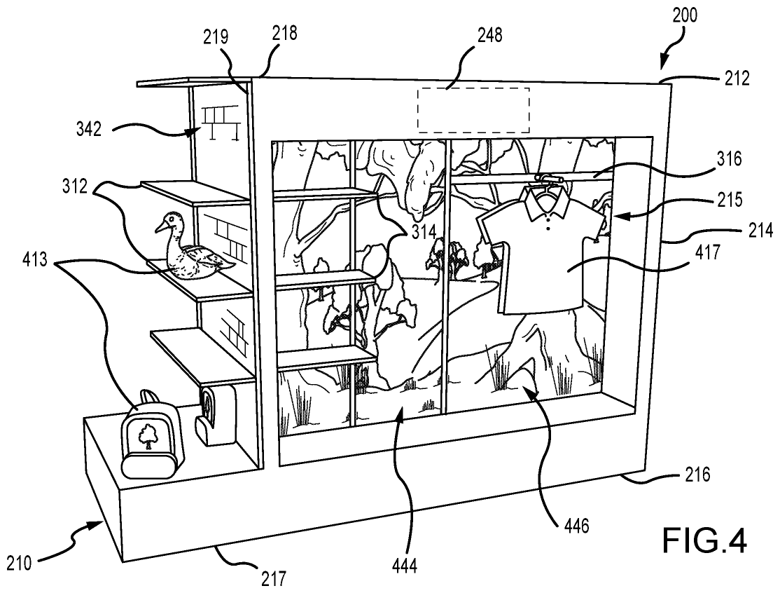

FIG. 4 illustrates the smart merchandise fixture 200 of FIGS. 2-3D in an on or display mode (in a manner similar to that shown in FIG. 3B) after reprogramming by a VIVID system, for example, to modify the media content used by the media output assembly 240 to suit differing products displayed in the fixture 200. Particularly, the products 314 and 317 have been replaced with end cap products 413 and front recessed space products 417. These products 413 and 417 may be associated with a different product line from the same company or a different company, e.g., be products associated with another film, be products for another season of the year by the same company or a different company, and so on.

As noted above, some of the content may be retained in the new programming such as the digital content 342 displayed by end or exterior display element 242 to provide a background (often with a still image) texture for products 413. However, the reprogramming (e.g., running the fixture 200 with a second control program with the same content and/or differing content that has been downloaded to the fixture controller (e.g., controller 116 over a network 104) by a VIVID system (such as system 150)) may also provide a second set of digital media content for use in operating the media output assembly 240. In the example of FIG. 4, new content has been provided for display elements 244, 246 and 248, and the media output assembly 240 is operating to provide displayed content 444, 446, 448 on these elements to create a new display experience behind the new product 417 and to provide a new branding/marketing label display with element 248. A reprogramming, which may be remotely accomplished, is effective in changing or updating the look and feel of the fixture 200 without requiring worker hours to modify the fixture's physical display assembly 210 and only to replace the product 214, 217 with product 414, 417. The same reprogramming may be performed concurrently (or independently in a sequential manner if desired) for all fixtures 200 across a wide geographic area that are used to display and/or sell the product 414, 417.

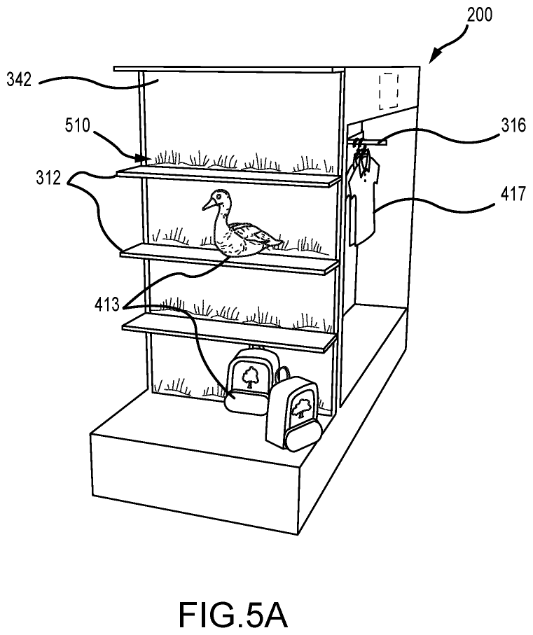

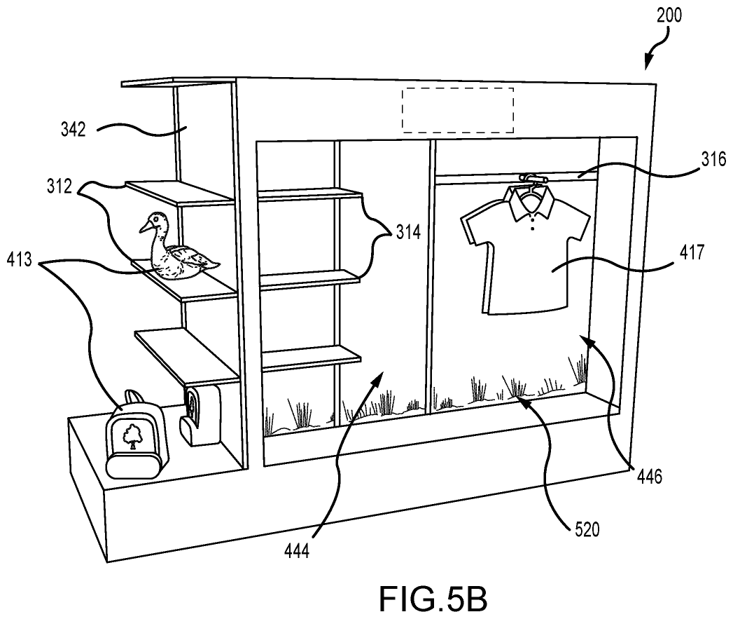

FIGS. 5A and 5B illustrate how the second digital content may include a subset of content used to modify or provide additional features (or visual effects) for the displayed content 342 and/or 442. In this example, the fixture 200 is being used to provide a seasonal or wintery look and feel for the products 413, 417. In this vein or same theme, displayed items/images 510 and 520 may be added to the displayed content 342, 444, and 446 (or to only one or two of these contents) to provide imagery of a pile or drift of snow on shelves 312 or on the base 216. FIGS. 5A and 5B are useful for showing how additional content may be displayed by the media output assembly 240 as it runs a second display control program provided by the reprogramming effort of the VIVID system (or by other reprogramming) periodically or at different times to change the fixture 200 without requiring manual updating of physical aspects of the fixture 200.

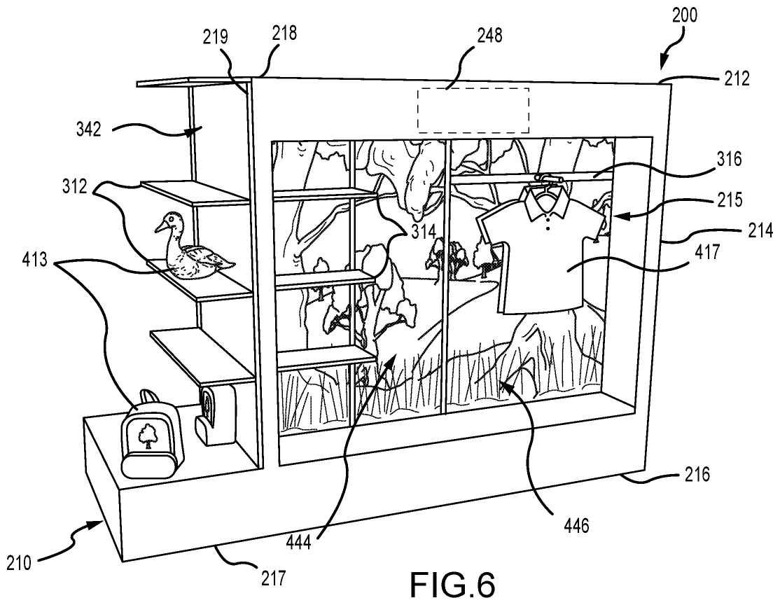

FIG. 6 illustrates the fixture 200 after a further reprogramming (third reprogramming) to change the digital media content (e.g., content 132 in FIG. 2) used to operate the interior display elements 244 and 246 without (in this case) a change in the displayed products/objects 413, 417. Such reprogramming may be desirable when a monitored fixture 200 is not creating the number or type of sales of the products 413, 417 and/or the type of consumer interactions with the fixture 200 and/or products 413, 417 such as based on analysis of inward and outward camera images, of sensors sensing changes in the levels of inventory of the products 413, 417. By remote reprogramming, an operator of a VIVID system 150 is able to change the marketing used (e.g., to provide a new marketing campaign) to try to achieve improvements in sales or at least consumer interaction. In this regard, as shown, the displayed content 644 and 646 differs from that shown in FIGS. 5A and 5B, and, in this case, it is coordinated between the two display elements 244 and 246 to create one very large video background/backdrop for the merchandise 417 (but, in other cases, the content may differ at least in part and work together or independently to achieve a desired optical effect).

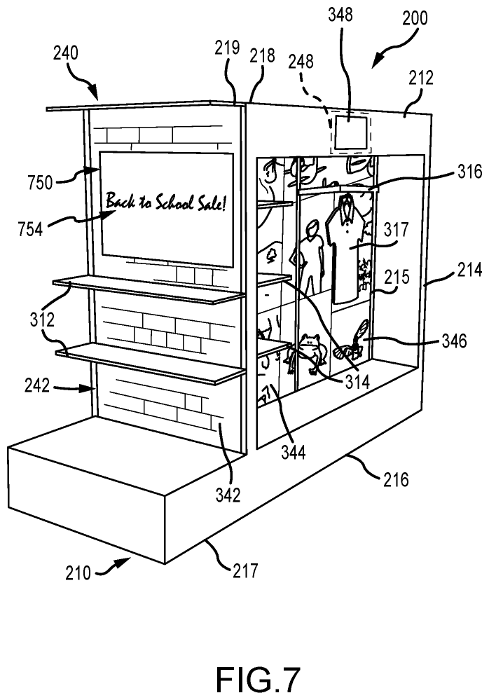

FIG. 7 illustrates the smart merchandise fixture 200 of FIG. 3A with a modification to include a camouflaged digital signage component 750 on its end cap portion (on sidewall surface 219) of the physical display assembly 210. The digital signage component 750 may be camouflaged with a scrim or other covering layer so as to be “invisible” to an observer/consumer until it is illuminated or operated to display a set of content 754 (e.g., images, printed messages, and so on) that may be coordinated with the other content displayed in fixture 200 to achieve a desired marketing for displayed products or for a product line or company providing such products. In other cases, the content 754 may be updated on a periodic basis with timing set by a display program or be updated with content to provide an interactive experience (e.g., based on monitoring of a nearby consumer, the content 754 may be retrieved from memory or created by the medial output assembly controller and/or its running software to be responsive to the consumer).

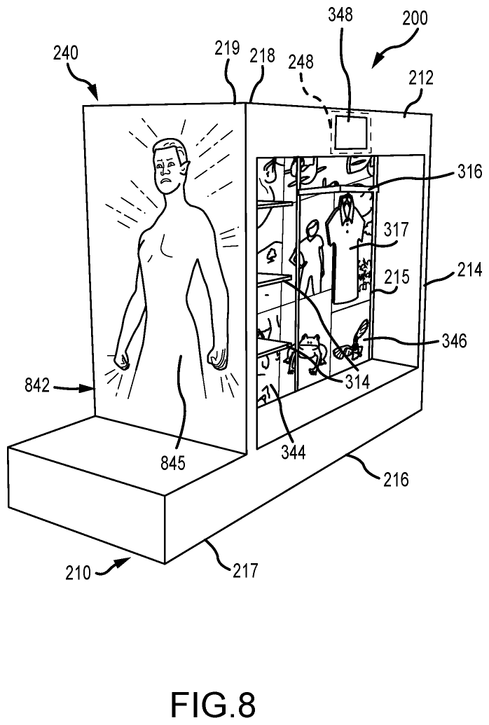

FIG. 8 illustrates the smart merchandise fixture 200 of FIG. 3A with a modification to include a magic movie poster-type display element 842 in the media output assembly 240 in place of digital display element (e.g., LCD or the like) 242. The displayed content 845 may be 2D or 3D, and the poster display element 842 may display static content and then, periodically (or in reaction to sensing a nearby consumer/observer or input from such consumer/observer), come alive with video or motion imagery and then return to the static mode (or to displaying static content). As with the other displayed content, the content 845 may be chosen to attract attention of consumers of the displayed products and/or to provide consumer education and/or brand awareness for the company making and/or distributing the products 417 (such as with displaying imagery from a movie and with products 417 being merchandise with a link or theme tied to the movie). In some cases, the content 845 may be varied over time with reprogramming to suit changes to the content displayed by the other display elements and/or to suit a new set of displayed products 417. FIG. 8 is useful for demonstrating that the display elements of the media output assembly 240 are not restricted to conventional monitors but may take the form of nearly any display device especially ones that are configured for changing the display/displayed content based on new input digital media feeds/content (e.g., content 132 of FIG. 1) with such content often being downloaded from a remote server (such as from VIVID system 150 in FIG. 1).

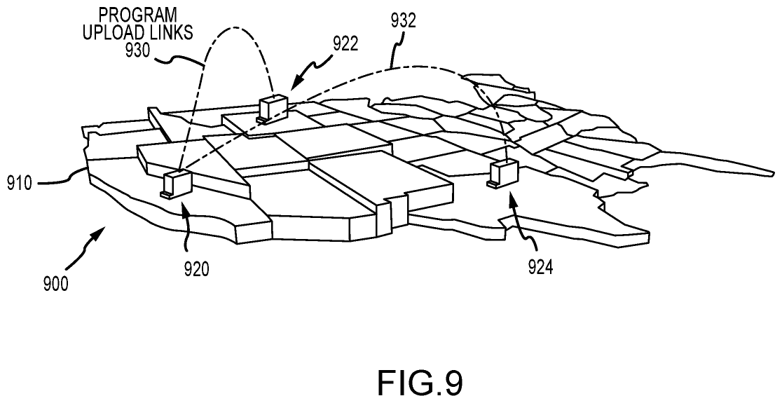

FIG. 9 is a schematic of a networked system 900 of smart fixtures 920, 922, 924 of the present description including a master fixture used to create digital content and programming for remote but networked fixtures in brick and mortar stores/locations (e.g., across one, two, or more states of the United States as shown as one useful example). In the system 900, a base or test fixture 920 may be configured to a desired display design or setting by a VIVID such as with the VMD(s) working with a fixture located at a corporate headquarters or office buildings with a particular product line and many choices of media content for use with the fixture's media output assembly.

Then, as shown with digital communication links 930, 932, the chosen program setting timing and use of a set of digital media content (e.g., audio, still images, video, and so on) is transferred to and downloaded onto fixtures 922 and 924 in a concurrent manner (e.g., a single push of content to all similarly operated fixtures 922 and 924). The fixtures 922, 924 may be loaded with the same products (typically, in the same way) as fixture 920, and the media output assembly of each operated to create a desired fixture look and feel as part of a coordinated marketing campaign that can be controlled centrally and remotely by an operator of a VIVID system in the same (or another) facility as the fixture 920. The fixtures 922, 924 may then be monitored by this (or another) VIVID system by having the outputs of their monitoring systems (in the form of system 140 of FIG. 1, for example) processed/analyzed for compliance with a product display design, for consumer interactions and/or reactions, and for inventory/stocking levels for each fixture in system 900 (with only two fixtures shown 922, 924 but it being understood the system 900 would operate similarly with tens, hundreds, or even thousands of such smart fixtures).

In some embodiments of the system 900, differing programs and/or content packages will be created using the fixture 920 for the same or different products such as to suit differing target consumers, to try two or more advertising campaigns to determine which is more effective, to reach consumers in differing countries or regions of a single country, and so on.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

For example, the display elements of a fixture may make use of projection technologies instead of monitor technologies to implement a smart fixture, with the projected content being changed as part of programming and reprogramming a fixture. In another example, the monitoring system may include a lighting sensor for sensing lighting levels for displayed products so as to allow remote monitoring of whether or not a fixture is configured to provide a desired/present minimum CRI or one falling within a predefined acceptable CRI range for a particular product or a particular fixture (or portion of a fixture).

In another example, the smart merchandise fixture is configured to provide an interactivity component or assembly that is communicatively coupled to a central server run by a company providing an e-commerce website for selling the products displayed in the smart merchandise fixture. The interactivity component or assembly may be adapted to mirror a mobile device operated by a consumer to provide the consumer the same or similar look and feel as provided by the e-commerce website when it is served to the mobile device, and, in some cases, the consumer is able to transfer their live session between the mobile device and the interactivity component. In this way, a consumer may research a product online and be directed to the smart merchandise fixture to see, pick up, try on, and otherwise interact with the displayed products, and the consumer may then purchase the product from the smart merchandise fixture and/or order from the e-commerce site using their mobile device or the interactivity component of the smart merchandise fixture. For example, when the displayed products are not of a desired size, color, or number, the consumer may order the products they desire as part of the hands-on or brick and mortar experience or when the consumer would rather not carry the product home they can choose for it to meet them there for their convenience.

We claim:

1. A system for remotely monitoring and reprogramming smart merchandise fixtures used to display products, comprising:
a display server system including memory storing a sensory display script configured for use with a smart merchandise fixture in which are positioned one or more of the products; and
a plurality of the smart merchandise fixtures communicatively linked with the display server system to receive the sensory display script and, in response, generate a sensory product display,
wherein each of the smart merchandise fixtures comprises:
a physical display assembly displaying the products; and
a media output assembly mounted on the physical display assembly and including at least one sensory rendering technology element operable by a controller to provide a sensory display proximate to the products based on the sensory display script.

2. The system of claim 1, wherein the display server system operates to generate and transmit a second sensory display script to at least one of the smart merchandise fixtures to reprogram the at least one of the smart merchandise fixtures and wherein the controller of the at last one of the smart merchandise fixtures responds to the reprogramming by operating the at least one sensory rendering technology element to provide a second sensory display using the second sensory display script.

3. The system of claim 2, wherein the sensory display script includes media content, the second sensory display script comprises second media content, and at least one the sensory rendering technology element comprises at least one imaging technology element and wherein the media content includes a program defining timing of operations of the at least one imaging technology element to display the media content and the second media content includes a second program defining a second timing of operations of the at least one imaging technology element to display the second media content.

4. The system of claim 2, wherein each of the smart merchandise fixtures includes a monitoring system sensing data related to the products in the physical display assembly including at least one of inventory levels and consumer interaction with the smart merchandise fixture or the products and wherein the sensed data is transmitted to the display server system for analysis.

5. The system of claim 4, wherein the second sensory display script is generated in response to results of the analysis.

6. The system of claim 4, wherein the analysis comprises running an image analysis algorithm to confirm compliance by operations and configuration of the smart merchandise fixture associated with the sensed data with a product display design for smart merchandise fixtures assigned to the smart merchandise fixture associated with the sensed data.

7. The system of claim 2, wherein the second sensory display script provides additional content modifying the sensory display to includes a changed or additional component relative to a displayed image or provides content that differs such that the second sensory display from the sensory display.

8. The system of claim 1, wherein the at least one sensory rendering technology includes at least one imaging technologies element comprising a monitor and wherein the sensory display script includes media content including a video.

9. The system of claim 1, wherein the media output assembly includes lighting and wherein the sensory display script includes media content defining at least one of the following for operating the lighting: a set of output colors, a timing of operations of one or more lights in the lighting, and a color rendering index (CRI) for lighting the products in the physical display assembly.

10. The system of claim 1, wherein the at least one sensory rendering technology element includes at least one imaging technologies element comprising a liquid crystal display (LCD), a poster display element switchable from a static mode to a motion mode, and a camouflaged digital signage element.

11. A smart merchandise fixture, comprising:
a physical display assembly configured to display merchandise;
a receiver for receiving communications from a remote server;
a fixture controller for processing the communications and, in response, storing media content in local memory; and
a media output assembly mounted on the physical display assembly and including a display element operable to provide a displayed image proximate to the merchandise using the media content,
wherein the fixture controller operates to process a second set of media content received by the receiver and, in response, reprogram the media output assembly to operate the display element to provide a second displayed image using the second set of media content.

12. The fixture of claim 11, wherein the media content includes a program defining timing of operations of the display element to display the media content and the second set of media content includes a second program defining a second timing of operations of the display element to display the second set of media content.

13. The fixture of claim 12, further comprising a monitoring system sensing data related to the merchandise in the physical display assembly including at least one of inventory levels and consumer interaction with the fixture or the merchandise and wherein the sensed data is transmitted to the remote server system for analysis.

14. The fixture of claim 13, wherein the second set of media content is generated in response to results of the analysis or a replacement of the merchandise with a second set of differing merchandise.

15. The fixture of claim 11, wherein the second set of media content provides additional content modifying the displayed image so that the second displayed image includes a changed or additional component relative to the displayed image or provides content that differs such that the second displayed image differs from the displayed image.

16. The fixture of claim 11, wherein the media output assembly includes lighting, wherein the media content defined at least one of the following for operating the lighting: a set of output colors, a timing of operations of one or more lights in the lighting, and a color rendering index (CRI) for lighting the products in the physical display assembly, and wherein the display element comprises a liquid crystal display (LCD), a poster display element switchable from a static mode to a motion mode, and a camouflaged digital signage element.

17. A method of displaying and monitoring merchandise in a fixture, comprising:
providing a smart fixture in a space, wherein the smart fixture includes a physical display assembly displaying products, a sensory display element adapted for rendering sensory stimuli, and a monitoring system;
operating the sensory display element to provide first sensory stimulus;
operating the monitoring system to sense data related to the displayed products;
processing the sensed data to monitor interactions with or inventory levels of the displayed products; and
in response to the processing, operating the sensory display element to provide second sensory stimulus or issuing a message to an operator of the smart fixture to restock the physical display assembly with an additional amount of the products.

18. The method of claim 17, wherein the monitoring system includes at least one of the following: a camera directed toward the products in the physical display assembly, a camera directed toward a space exterior to the physical display assembly to capture images of consumers, an RFID reader, a barcode reader, and a pressure sensor in the physical display assembly.

19. The method of claim 17, wherein the processing of the sensed data includes performing image analysis of images of the physical display assembly, the merchandise, and the display element to compare configuration or operations of the smart fixture with a product display design associated with the smart fixture.

20. The method of claim 17, further comprising receiving or sensing user input from a consumer interacting with the products or with the physical display assembly and, in response, operating the sensory display element to modify the first sensory stimulus or initiating the operating the sensory display element to provide the second sensory stimulus.

21. The method of claim 17, further comprising operating an interactivity component associated with the smart fixture to link a consumer to an e-commerce site associated with the products and, with the interactivity component, receiving user input interacting with the e-commerce site related to the products.
